(19) United States
(12) Patent Application Publication
(10) Pub. No.: US 2024/0204193 A1
(43) Pub. Date: Jun. 20, 2024

(54) BINDER COMPOSITION FOR NEGATIVE ELECTRODE AND APPLICATIONS THEREOF

(71) Applicant: Arkema Inc., King of Prussia, PA (US)

(72) Inventors: Jinbao CAO, King of Prussia, PA (US); Wenjun WU, King of Prussia, PA (US); Ramin AMIN-SANAYEI, King of Prussia, PA (US); Brian T. KOO, King of Prussia, PA (US); Jean-Marc SUAU, Lucenay (FR); Marine DUVER, Villeurbanne (FR)

(21) Appl. No.: 18/284,896

(22) PCT Filed: May 12, 2022
(86) PCT No.: PCT/US2022/028903

§ 371 Date: Sep. 29, 2023

Related U.S. Application Data
(60) Provisional application No. 63/188,509, filed on May 14, 2021.

(51) Int. Cl. H01M 4/62; C09D 5/24; C09D 7/61; C09D 125/14; C09D 133/06; H01G 11/28; H01G 11/50; H01M 4/13; H01M 10/0525

(52) U.S. Cl. CPC H01M 4/622; C09D 5/24; C09D 7/61; C09D 125/14; C09D 133/062; C09D 133/064; C09D 133/066; H01G 11/28; H01G 11/50; H01M 4/13; H01M 10/0525

(57) ABSTRACT

A composition including a polymeric binder for the negative electrode of a secondary energy storage device is provided. The polymeric binder provides a matrix for particulate electrode-forming materials, which may include an active material and a conductive material. The polymeric binder contains acid functional groups. The polymeric binder also contains other functional monomers, which also may contribute to the performance of the polymeric binder in the negative electrode.

### FIELD OF THE INVENTION

The invention relates to binder compositions useful for negative electrodes of non-aqueous secondary batteries.

### BACKGROUND

There has been increasing interest in light weight and high energy density secondary (rechargeable) battery technology. Lithium-ion batteries (LIB) have been used widely as the power source for many devices, such as consumer electronics, electric vehicles, and power tools. Recently, the growing popularity of zero-emission electric vehicles, particularly long-range electric vehicles, has increased demand for LIB technology with further improved energy density. To improve battery energy density and overall performance, different components of a battery are being investigated. These components include the negative electrode, the positive electrode, the electrolyte and the separator. In particular, the negative electrode may have potential to boost battery energy density if improved binders are used for the anode.

US 2013/0330622 discloses a negative electrode for a secondary battery, including a negative electrode active material, a binder, and a water-soluble polymer. The water-soluble polymer may be a copolymer containing 15 wt % to 50 wt % of an ethylenically unsaturated carboxylic acid monomer unit, 30 wt % to 70 wt % of a (meth)acrylic acid ester monomer unit, and 0.5 wt % to 10 wt % of a fluorine-containing (meth)acrylic acid ester monomer unit.

U.S. Pat. No. 9,461,308 discloses an electrode for a lithium ion secondary battery. The electrode includes an electrode active material and a water-soluble polymer that is a copolymer including 1 to 30 wt % of an aromatic vinyl monomer unit, 20 to 60 wt % of an unsaturated carboxylic acid monomer unit, and 0.1 to 5 wt % of a crosslinkable monomer unit. The aromatic vinyl monomer is a sodium styrene sulfate monomer.

U.S. Pat. No. 10,224,549 discloses a high acid-containing water-soluble acrylic polymer used in combination with traditional binder as the binder solution for the active material. The binder composition includes a particulate binder such as styrene butadiene rubber (SBR) and a small amount (<5%) of the high acid-containing water-soluble polymer. In addition, the high acid-containing water-soluble polymer does not contain other functional monomers.

US 2020/0203707 discloses an electrodepositable coating composition including a binder having a pH-dependent rheology modifier that includes the residue of a crosslinking monomer and/or a monoethylenically unsaturated alkylated alkoxylate monomer; an electrochemically active material and/or an electrically conductive agent; and an aqueous medium.

US 2020/0203704 discloses an electrodepositable coating composition including a fluoropolymer; an electrochemically active material and/or an electrically conductive agent; a pH-dependent rheology modifier; and an aqueous medium including water.

Water-based slurries are often preferred over solvent-based slurries in fabrication of the electrodes of such secondary batteries due to environmental concerns. Typically, these electrodes are manufactured by dispersing the electrode-forming ingredients in water, casting the slurry or paste on the current collector as a thin film and then allowing the film to dry to form the electrode. The function of the polymeric binder is to bind the electrode-forming particulates together onto the current collector. The electrode-forming particulates of the negative electrode (anode) for these secondary lithium ion batteries typically includes an active material (e.g. carbonaceous material) that can reversibly absorb and release or host (intercalate) lithium ions to create reaction sites for lithium ion electrochemical reactions (battery charging/discharging), a conductive additive, a rheology modifier and a polymeric binder. The anode active material is a substance that is capable of donates or accepts electrons during the charging/discharging cycle. The conductive additive is typically used to improve the conductivity of the negative electrode (anode), which reduces the battery's internal resistance, and consequently boosts power output of the battery. A rheology modifier is typically present in the anode slurry formulation to adjust the slurry rheology for the electrode manufacturing casting process. Examples of rheology modifiers used in negative electrode formulations include carboxymethylcellulose (CMC) and polyacrylic acid (PAA). The function of the polymeric binder is to bind the anode components together onto the current collector. Styrene-butadiene rubber (SBR) latex generally is the dominant anode binder.

There are reports [K. Hays et al; J. Phys. Chem. C 2018, 122, 18, 9746-9754] that amorphous silicon (Si) can be oxidized and generate H₂ gas during aqueous slurry preparation for lithium ion battery application. The use of Si in secondary batteries is important because it may have the possibility to increase the energy density of Li ion battery anodes. However, H₂ generation imposes a safety concern during large-scale battery fabrication.

The ongoing industrial trend to improve the battery energy density and the advancement of anode active material presents new challenges for traditional polymeric binders. A need remains for an anode binder that provides a secondary battery having high energy density, no H₂ generation and excellent service life. Binders that provide functional benefits to the anode in addition to simply physically holding the active material and conductive materials together and providing physical flexibility are needed.

One objective of the invention is to provide a new composition including a polymeric binder for the negative electrode of an electrochemical electrical energy storage device.

In the present invention, it was surprisingly found that the disclosed polymers which include certain functional groups may be used as the anode binder in negative electrode formulations to provide a negative electrode with low resistivity, good adhesion to the current collector substrate, and low VOC content. The resulting anode binders and the resulting negative electrodes for secondary batteries have good adhesion to the current collector as well as providing functional benefits to the anode and thus the battery.

Unexpectedly, binders of this invention also may prevent generation of Hz gas during preparation of amorphous Si-containing water-borne slurries. This is an advantage for anode production.

### SUMMARY

The present invention is directed to compositions for use as a negative electrode on a current collector within an electrical energy storage device containing a non-aqueous electrolyte. The compositions of the invention comprise, consist essentially of, or consist of: a) at least one particulate electrode-forming material; b) a polymeric binder; and c) from 0-40% by weight of the polymeric binder of at least one crosslinking agent capable of reacting with the polymeric binder b).

The polymeric binder b), comprises, consists of, or consists essentially of the following as polymerized monomers:
i) 0.1-50% by weight of the polymeric binder of at least one ethylenically unsaturated ionic monomer comprising at least one functional group selected from carboxylate, sulfonate, sulfate, phosphate, phosphonate. these functional groups may be present in acid form, and/or present as salts, and/or present as anhydrides,
ii) 10-99% by weight of the polymeric binder of at least one non-ionic monoethylenically unsaturated monomer,
iii) 0-5% by weight of the polymeric binder of at least one ethylenically unsaturated monomer comprising at least one functional groups that may promote post-polymerization crosslink reactions, the at least one functional group may comprise, consist of or consist essentially of N-methylol amide, N-alkylol amide, hydroxyl group, epoxy, silane, keto or combinations thereof,
iv) 0-5% by weight of the polymeric binder of at least one monomer comprising, consisting of or consisting essentially of at least two ethylenic unsaturations
v) 0-30% by weight of the polymeric binder of at least one ethylenically unsaturated monomer comprising, consisting of, or consisting essentially of at least one functional group selected from silane, ureido, amine, hydroxyl group, and combinations thereof,
vi) 0-30% by weight of the polymeric binder of at least one oxyalkylated monomer with ethylenic unsaturation and terminated by a hydrogen or aryl or alkyl chain (which may be hydrophobic), having the following formula:

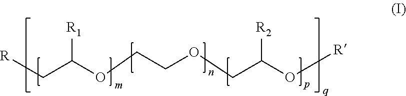

wherein:
m and p represent a number of alkylene oxide units of from 0 and 150, n represents a number of ethylene oxide units of from 5 and 150,
q represents a whole number at least equal to 1 and such that 5≤(m+n+p)q≤150, and preferentially such that 15≤(m+n+p)q≤120,
R₁ and R₂ represent methyl or ethyl,
R represents a group comprising, consisting of, or consisting essentially of at least one polymerizable olefinic unsaturation, preferably a group chosen from acrylate, methacrylate, acrylurethane, methacrylurethane, vinyl, allyl, methallyl, isoprenyl, an unsaturated urethane group, in particular acrylurethane, methacrylurethane, α-α′-dimethyl-isopropenyl-benzylurethane, allylurethane, more preferably a group chosen from acrylate, methacrylate, acrylurethane, methacrylurethane, vinyl, allyl, methallyl and isoprenyl, esters of maleic acid, esters of itaconic acid, esters of crotonic acid, even more preferably a methacrylate group, and mixtures thereof, and
R′ represents a hydrogen or aryl chain with 5 to 60 carbon atoms or alkyl chain end with 1 to 60 carbon atoms.

The total of components b) i) through b) vi) add up to 100% by weight of polymeric binder b). The polymeric binder b) has a Tg of 55° C. or less and/or a minimum film forming temperature of 25° C. or less.

The composition may also include the following optional components:
c) from 0-40% by weight of the polymeric binder of at least one crosslinking agent capable of reacting with the polymeric binder b);
d) from 0-10% by weight of the polymeric binder of one or more wetting agents,
e) from 0-10% by weight of the polymeric binder of one or more dispersing agents,
f) from 0-10% by weight of the polymeric binder of one or more volatile organic compounds (VOC), and/or adhesion promoters, and/or coalescent agents,
g) from 0-200% by weight of the polymeric binder of one or more rheology modifier additives,
h) from 0-10% by weight of the polymeric binder of one or more additives comprising, consisting of or consisting essentially of anti-setting agents, surfactants, and mixtures thereof.

The composition for use as an electrode as disclosed herein is typically prepared as a slurry, although it may be in the form of a solution, a dispersion, or a paste. Forming the electrode may be done by applying a layer of the electrode forming slurry composition to the current collector. The conductive layer is then dried, to form the layer of electrode material, i.e. the active material layer, which is adhered to the current collector.

### DETAILED DESCRIPTION

The binder(s) of the invention provide a matrix for the particulate electrode-forming materials, which typically include an active material and a conductive material.

As used herein, the term “electrode” refers to the dried layer of the electrode-forming slurry composition that is cast onto the current collector. Typically, electrodes are manufactured by casting the slurry or paste of dispersed electrode-forming ingredients and binder(s) as a thin film and then allowing the film to dry to form an electrode. This dried film is referred to as the electrode.

As used herein, the term “electrode assembly” is the combination of the current collector and the dried electrode that is dried thereon. The slurry or paste of dispersed electrode-forming ingredients and binder(s) can be cast onto current collector such as an aluminum, copper or nickel foil to form the electrode assembly. The electrode assembly can be further coated with a separator-forming slurry such as alumina and binder dispersed in water. The separator slurry can be cast simultaneously with the electrode slurry in a one-step process using a dual or a multi-die in a wet-on-wet process. Alternatively, after the electrode is dried, the separator slurry may be cast onto the electrode, or a free standing separator can be adhered onto the electrode surface. The electrode assembly therefore includes the current collector, the dried electrode film, and optionally a separator film on the top surface of the electrode.

As used herein, the term “slurry” means a free-flowing or flowable and/or pumpable suspension including fine solid materials and binder in water. Such fine solids may include, inter alia, polymeric binder particles, in addition to the solid particles that are usually the electrochemically active material(s) and conductive materials(s) necessary to form the electrode for a secondary battery. Additives may also be dissolved in the water such as dispersing agents used to improve the quality dispersion, of the fine solid material.

The composition for use as an electrode can be deposited by any method known in the art. Non-limiting examples of such application methods include spraying, rolling, draw bar application, bird bar application, gravure, slot coating, or other coil coating methods. The composition is dried optionally with heat. The coating of the composition may be optionally calendered before or after the drying step, to remove water and any other volatile materials. The drying times, temperatures, and vacuum used can be adjusted to achieve the desired drying.

The current collector may be in the structural form of a mesh, a foam, a foil, a rod, or other morphology that does not interfere with current collector function. Current collector materials vary depending on whether an electrode is a positive electrode or a negative electrode. The most common current collectors for a negative electrode are sheets or foils of aluminum (Al⁰), copper (Cu⁰) or nickel (Ni⁰) metal. The electrode material is applied to and must adhere to the surface of the current collector of the lithium ion battery.

Different crosslinking functionalities and/or reactive functionalities may be incorporated into the polymeric binders b) of the invention to balance mechanical properties and enhance film formation when applied to a current collector substrate. There are two classes of crosslink functionalities that may be present in the polymeric binder b). These are in-situ crosslink functionality and post-polymerization crosslink functionality. The in-situ crosslink functionalities crosslink the polymeric binder b) during polymerization. The post-polymerization crosslink functionalities crosslink the polymeric binder b) during and after negative electrode film formation when the composition including the polymeric binder b) is applied to the current collector substrate to form the electrode.

Thus, a composition for use as an electrode on a current collector within an energy storage device containing a non-aqueous electrolyte is provided. The composition comprises, consists of or consists essentially of a) at least one particulate electrode-forming material, b) a polymeric binder, and optionally, from 0 to 40% by weight of the polymeric binder, of c) one or more optional crosslinking agents capable of reacting with the polymeric binder b). The crosslinking agent c) used depends on the type of post-crosslink monomer included in the binder 25 b). Certain post-crosslink functionalities included in the binder b) do not require an external crosslinking agent c).

Particulate Electrode Forming Material a)

The particulate electrode forming material a) includes particulate active materials and conductive particles that are held together (physically and/or chemically) by the polymeric binder b). The active materials are materials that are capable of intercalating lithium ions, i.e., are able to absorb/release lithium ions. Such active materials are known in the art. Conductive particles are also known in the art and are materials capable of conducting electrons. Certain materials are capable of performing both functions in an electrode.

The particulate electrode-forming materials a) may include but are not limited to a conductive carbon additive, carbon nanotubes (CNTs), synthetic graphite, natural graphite, hard carbon, activated carbon, carbon black, graphene, mesoporous carbon, amorphous silicon, semi-crystalline silicon, silicon oxides, silicon nanowires, tin, tin oxides, germanium, lithium titanate, mixtures or composites of the aforementioned materials, and/or other materials known in the art or described herein as suitable for use as the anode in a lithium ion battery. These particulates may include active materials, i.e., materials capable of intercalating (accepting) lithium ions, and conductive materials. The electrode film of a lithium ion capacitor and/or a lithium ion battery can include about 80 weight percent, preferably up to 90, or 94, and more preferably up to 98 weight percent of the particulate anode-forming materials a), after drying. These electrode-forming materials a) are typically in the form of solid powders.

Conductive carbon materials such as carbon black and graphite powders are widely used in positive and negative electrodes to decrease the inner electrical resistance of an electrochemical system. Non-limiting examples of conductive carbon may include furnace black, acetylene black, CNT, fine graphite powder, vapor deposited graphite fibers, and Ketjen carbon black. The typical loading level of the conductive carbon relative to the active material in the electrode forming materials a) is usually within the range of 0.1% by weight to 20% by weight, and more preferably within the range of 0.5% by weight to 10% by weight of the total amount of the particulate electrode-forming materials a).

The amount of the particulate electrode-forming materials a) (including both the active material and the conductive carbon) present in the electrode forming composition, may be from 50 wt % to 99 wt % of the total dried weight of the composition, preferably from 80 to 98 and most preferably from 94 to 98 wt % of the total dried weight of the composition.

Polymeric Binder b)

The anode in the present invention further includes a polymeric binder. The binder is present in the electrode. One function of the binder is to bind together particulate anode forming materials to form the electrode. The polymeric binder also may serve to adhere the electrode to the current collector. The polymeric binder b) may be in the form of polymerized particles. These particles may be provided in the form of an emulsion or latex.

The inventors surprisingly found that, preferably, the Tg of the disclosed polymeric binder b) should be within a certain range. The Tg is the temperature below which the physical properties of polymers changes from thermoplastic (e.g. flexible, soft, stretchable) to those of the glassy state which limits flexibility and elongation of the polymeric binder b). As a result, upon bending of electrode, cracks (visible or micro-cracks) can form in electrodes which in turn deteriorate electrode performance. For ease of electrode handling and good electrode performance, the Tg of the polymeric binder b) may be at about or preferably below room temperature, i.e. below 55° C., below 45° ° C., below 35° C., below 25° C., below 20° C., or below 10° C., according to certain embodiments.

Without being bound to any theory, in order to have a satisfactory electrode integrity using the electrode forming composition disclosed herein, as the aqueous phase evaporates, the polymeric binder b) particles in the form of a latex (emulsified particles) that comprise the polymeric binder b) coalesce into a continuous network which can hold the active materials and conductive carbon in an interconnected electrode network. The minimum film formation temperature (MFFT) of the polymeric binder b) latex particles is the minimum temperature where the coalescence of the polymeric particles occurs as the water evaporates to form continuous films. The MFFT is the minimum temperature at which the polymeric binder b) particles coalesce to form a continuous film. The polymeric binder b) advantageously has an MFFT near or below room temperature, i.e., below 55° C., below 50° C., below 45° C., below 35° C., below 25° C., or below 20° C., according to certain embodiments.

There is little or no need for adding coalescents that contribute to the volatile organic content (VOC) of the electrode forming slurry composition of this invention. In an embodiment, the electrode forming composition has a VOC content of from 0 to less than 5 wt %, in another embodiment from 0 to less than 1 wt %, and in still another embodiment from 0 to less than 0.1 wt %.

As discussed in more detail below, the polymeric binder b), includes, as polymerized monomers, a number of monomers. The selection of polymerization method for the disclosed polymeric binder b) is not particularly limited. Any polymerization method can be used to synthesize the disclosed binder. Non-limiting methods may include solution polymerization, emulsion polymerization, bulk polymerization, and suspension polymerization, free radical polymerization, controlled polymerization, and ionic polymerization. In one embodiment, polymeric binder b) is prepared through free radical polymerization via emulsion polymerization.

The number average molecular weight of the disclosed binder is preferably 1000 g/mol or more, and more preferably 5000 g/mol or more, and even more preferably 10,000 g/mol or more. As used herein, number average molecular weights are determined by gel permeation chromatography, using polystyrene standards.

The polymeric binder b) may have a volume average particle size of from 30 to 500 nm, or can be a mixture of various particle sizes from 30 to 500 nm. The particle size is preferably within the range of 30-400 nm, and more preferably within the range of 40-350 nm, and even more preferably within the range of 50-300 nm. As used herein, volume average particle sizes are determined by dynamic light scattering (DLS).

The loading of the polymeric binder b) in the composition relative to the electrode forming materials a) is preferably 1% by weight or more binder, more preferably 2% by weight or more, and preferably 30% by weight or less, and more preferably 20% by weight or less. When the loading of the polymeric binder b) is within the aforementioned range, it can provide good binding performance.

### Ethylenically Unsaturated Ionic Monomer i)

The polymeric binder b) contains a certain weight percentage of monoethylenically unsaturated monomer i) comprising, consisting of, or consisting essentially of at least one functional group selected from carboxylate, sulfonate, sulfate, phosphate, phosphonate, in acid, and/or salt, and/or anhydride form.

The disclosed polymeric binder b) containing a certain percentage of functional group containing monomers i) may have increased viscosity upon neutralization treatment in aqueous solution. Hence, the disclosed polymeric binder b) may function as a self-thickening binder in an anode slurry. The self-thickening binder can be used with or without a traditional rheology modifier, e.g. carboxymethylcellulose (CMC), in the composition disclosed herein. The neutralization step may be important for providing a functional self-thickening binder. The completely or partially neutralized binder should have sufficient solubility to swell in aqueous solution to increase the solution viscosity. Some polymeric binder b) examples containing acid functional groups as monomer i) may have tunable aqueous solution viscosity upon pH adjustment. The tunable solution rheology of the polymeric binder b) may enable them to function as a self-thickening binder in an anode slurry with or without traditional rheology modifiers.

The weight percentage of the monoethylenically unsaturated ionic monomer i) included in the disclosed polymeric binder b) is preferably within the range of 0.1-50 wt % by weight, and more preferably within the range of 1-45 wt % by weight, and particularly preferably within the range of 5-45 wt % by weight of the polymeric binder b). The selection of the monoethylenically unsaturated ionic monomer i) is not particularly limited. Non-limiting examples may include (meth) acrylic acid, 2-carboxyethyl acrylate, 2-polycarboxy ethyl acrylate, mono-ester of itaconic acid, maleic acid, fumaric acid, crotonic acid, itaconic acid, 2-acrylamide-2-methylpropane sulfonic acid, 4-styrenesulfonic acid, vinylsulfonic acid, 2-sulfoethyl methacrylate, phosphate esters of polyalkylene glycol mono(meth)acrylate, polyalkylene glycol allyl ether phosphate, vinylphosphonic acid, 2-(methacryloyloxy)ethyl phosphonic acid, and mixtures thereof. Also suitable are acid forms, and or salt forms and/or anhydride forms, (if chemically possible) of any of these monomers. Preferred are 0.1-50 wt %, more preferred are 1-45 wt %, and most preferred are 5-45 wt %.

Non-Ionic Monoethylenically Unsaturated Monomer ii)

The polymeric binder b) may further comprise, consist of or consist essentially of one or more non-ionic monoethylenically unsaturated monomers ii). The selection of the non-ionic monoethylenically unsaturated monomer ii) is not particularly limited. Non-limiting examples may include acrylic and methacrylic acid esters, such as C1 to C12 alkyl (meth)acrylates, styrene and derivatives thereof, vinyl acetate, vinyl versatate, (meth)acrylamide, (meth)acrylonitrile and derivatives thereof, diisobutylene, vinylpyrrolidone, vinylcaprolactam and mixtures thereof. Non-ionic monomers ii) that provide corresponding low Tg polymers are preferred for the disclosed polymeric binder b). For example, ethyl acrylate, butyl acrylate, and 2-ethylhexyl acrylate are preferred to lower the Tg of the disclosed polymeric binder a). The weight percentage of the non-ionic monoethylenically unsaturated monomer ii) in the disclosed polymeric binder b) is preferably within the range of 10 to 99 wt % by weight, and more preferably within the range of 20 to 95 wt % by weight, and particularly preferably within the range of 30 to 90 wt % by weight of the polymeric binder b).

Ethylenically Unsaturated Monomer Including Post-Crosslinkable Functional Groups iii)

The disclosed polymeric binder b) may further comprise, consist of or consist essentially of one or more crosslinkable monomers iii) that include functional groups that may enable post-polymerization crosslink reactions. If more than one functional group is present, the functional groups may be the same or different. Suitable functional groups that can enable post-polymerization crosslink reactions may be selected from at least one of N-methylol amide, N-alkylol amide, hydroxyl group, epoxy, silane, and keto groups. The selection of the crosslinkable ethylenically unsaturated monomer iii) is not particularly limited. Non-limiting examples of the post-polymerization crosslinkable ethylenically unsaturated monomer iii) may comprise, consist of or consist essentially of N-methylol(meth)acrylamide, vinyl glycidyl ether, allyl glycidyl ether, glycidyl (meth)acrylate, diacetone acrylamide, acetoaetoxyethyl methacrylate, (meth)acryloxyalkyltrialkoxysilanes, vinyltrialkoxysilanes and mixtures thereof. The weight percentage of the crosslinkable ethylenically unsaturated monomer iii) in the disclosed polymeric binder b) is preferably within the range of 0-5 wt % by weight of the polymeric binder b), more preferably from 0.1 to 3 wt % and most preferably from 0.2 to 2 wt % of the polymeric binder b).

Monomers Including at Least Two Ethylenic Unsaturations iv)

The polymeric binder b) may also comprise, consist of or consist essentially of at least one monomer comprising at least two ethylenic unsaturations iv). These monomers comprising at least two ethylenic unsaturations iv) are capable of in-situ crosslinking of the polymeric binder, meaning the binder b) is crosslinked during polymerization. Non-limiting examples of these monomers iv) are allylic ethers obtained from polyols; preferably allylic ethers obtained from polyols and selected from pentaerythritol, sorbitol, or sucrose; acrylic or methacrylic esters obtained from polyols, preferably acrylic or methacrylic esters obtained from polyols and selected from pentaerythritol, sorbitol, or sucrose; divinyl naphthalene, trivinylbenzene, 1,2,4-trivinylcyclohexane, triallyl pentaerythritol, diallyl pentaerythritol, diallyl sucrose, trimethylolpropane diallyl ether, 1,6-hexanediol di(meth)acrylate, allyl (meth)acrylate, diallyl itaconate, diallyl fumarate, diallyl maleate, butanediol dimethacrylate, ethylene di(meth)acrylate, poly(ethylene glycol) di(meth)acrylate, trimethylolpropane tri(meth)acrylate, methylenebis(meth)acrylamide, triallylcyanurates, diallyl phthalate, divinylbenzene, and mixtures thereof. More preferred monomers iv) are 1,6-hexanediol di(meth)acrylate, allyl (meth)acrylate, ethylene di(meth)acrylate, poly(ethylene glycol) di(meth)acrylate, trimethylolpropane tri(meth)acrylate, diallyl phthalate, divinylbenzene and mixtures thereof. Most preferred monomers iv) are 1,6-hexanediol di(meth)acrylate, allyl (meth)acrylate, poly(ethylene glycol) di(meth)acrylate, diallyl phthalate, divinylbenzene.

These monomers iv) may be present in the polymeric binder b) at from 0-5% wt %, preferably in the range of from 0.01-3 wt % and more preferably within the range of 0.05-2 wt %, and particularly preferably within the range of 0.1-1 wt % by weight of the polymeric binder b).

### Ethylenically Unsaturated Monomers Including Functional Groups v)

The inventive polymeric binder b) may further comprise, consist of or consist essentially of one or more ethylenically unsaturated monomers v) that include functional groups that may improve the interaction between the binder and the electrode active materials. These functional groups may also improve the interaction between the binder and the electrode conductive materials. The functional groups in the monomer v) may be comprise, consist of or consist essentially of at least one of silane, ureido, amine, hydroxyl group, and combinations thereof.

The selection of monomers v) is not particularly limited. For example, the monomers v) may be ethylenically unsaturated monomers with functional groups comprising, consisting of or consisting essentially of at least one of silane, ureido, amine and hydroxyl group. Non-limiting examples of monomers containing these functional groups comprise (meth)acryloxyalkyltrialkoxysilanes, vinyltrialkoxysilanes, (meth)acrylate ester of substituted urea, (meth)acrylamide of substituted urea, allyl ether of substituted urea, aminoalkyl (meth)acrylate, hydroxyalkyl (meth)acrylate. These functional ethylenically unsaturated monomers v) may be optionally used alone or in combination to improve the polymeric binder b)'s performance in the electrode.

According to an embodiment, monomers v) are selected from at least one of (meth)acryloxyalkyltrialkoxysilanes, vinyltrialkoxysilanes, (meth)acrylate ester of substituted urea, (meth)acrylamide of substituted urea, allyl ether of substituted urea, aminoalkyl (meth)acrylate, hydroxyalkyl (meth)acrylate, and mixtures thereof.

According to another embodiment, monomers v) are selected from at least one of (meth)acryloxyalkyltrialkoxysilanes, vinyltrialkoxysilanes, aminoalkyl (meth)acrylate, hydroxyalkyl (meth)acrylate, and mixtures thereof.

The weight percentage of the ethylenically unsaturated functional monomers v) is preferably within the range of 0-30 wt %, preferably the range of 0.01-10 wt %, and more preferably within the range of 0.05-7.5 wt %, and even more preferably within the range of 0.1-5 wt % by weight of the polymeric binder b).

Notably, the monomers v) may include silane or hydroxyl groups, as may some of the monomers iii). Thus, where monomers v) and iii) both include one or more of silane and hydroxyl groups, there may be up to 35 wt % of a monomer including a silane or hydroxyl group or epoxy group in the polymerizable binder b), by weight of the polymeric binder b).

Oxyalkylated Monomer with Ethylenic Unsaturation and Terminated by a Hydrogen or Aryl or Alkyl Chain vi)

The disclosed polymeric binder b) may further comprise, consist of or consist essentially of an oxyalkylated monomer or monomers with ethylenic unsaturation and terminated by a hydrogen or aryl chain with 5 to 60 carbon atoms or alkyl chain with 1 to 60 carbon atoms, having the following formula:

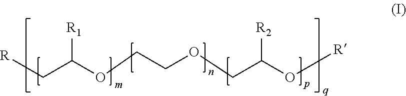

wherein:
m and p represent a number of alkylene oxide units of between 0 and 150,
n represents a number of ethylene oxide units of between 5 and 150,
q represents a whole number at least equal to 1 and such that 5≤(m+n+p)q≤150, and preferentially such that 15≤(m+n+p)q≤120,
R₁ and R₂ represent methyl or ethyl,
R represents a group comprising, consisting of, or consisting essentially of at least one polymerizable olefinic unsaturation, preferably a group chosen from acrylate, methacrylate, acrylurethane, methacrylurethane, vinyl, allyl, methallyl, isoprenyl, an unsaturated urethane group, in particular acrylurethane, methacrylurethane, α-α′-dimethyl-isopropenyl-benzylurethane, allylurethane, more preferably a group chosen from acrylate, methacrylate, acrylurethane, methacrylurethane, vinyl, allyl, methallyl and isoprenyl, esters of maleic acid, esters of itaconic acid, esters of crotonic acid, even more preferably a methacrylate group, and mixtures thereof, and
   R′ represents a hydrogen or aryl chain with 5 to 60 carbon atoms or alkyl chain end with 1 to 60 carbon atoms. The weight percentage of the oxyalkylated monomer vi) in the disclosed polymeric binder b) is preferably within the range of 0-30 wt %, and more preferably within the range of 0-20 wt %, and particularly preferably within the range of 0.1-20 wt % by weight of the polymeric binder b).

### Crosslinking Agents c)

The disclosed composition may also comprise, consist of or consist essentially of an optional crosslinking agent c). The crosslinking agent c) may react with functional groups of the disclosed polymeric binder b). For example, the post-crosslinkable functionalities in monomer iii) may be crosslinked with or without external agents. That means some of the post-crosslinkable functionalities may react with themselves to crosslink. However, some of the post-crosslinkable functionalities in iii) may require external agents to react with to effect crosslinking. The crosslinking agents c) referred herein is a component separate from the polymeric binder b) which is capable of reacting with some of the post-crosslinkable functionalities in monomer iii). The crosslinking agent c) may be added to the polymeric binder b) during binder preparation. The crosslinking agent c) may also or instead be added to the negative electrode slurry during electrode manufacturing as a two pack binder composition. The selection of the crosslinking agent c) is not particularly limited. Any crosslinking agent that comprises two or more functional groups that can react with the disclosed polymeric binder b) or the materials present in the negative electrode may be used as the crosslinking agent c). Non-limiting examples of the reactive functional groups within the crosslinking agent c) comprise silane, epoxy, amine, alcohol, blocked isocyanate, aziridine, and carbodiimide. Suitable crosslinking agents c) include but are not limited to at least one of alkoxysilanes, alkoxysilanes derivatives, dihydrazides, polyfunctional hydrazides, diamines, polyfunctional amines, diepoxies, polyfunctional epoxies, diols, polyols, polyfunctional blocked isocyanate, polyfunctional aziridine, polyfunctional carbodiimide, and mixtures thereof.

According to an embodiment, crosslinkers c) may be selected from at least one of γ-glycidoxypropyltrimethoxysilane, 3-glycidoxypropylmethyldiethoxysilane, trimethoxypropylsilane, adipic acid dihydrazide, sebacic acid dihydrazide, valine dihydrazide, isophthalic dihydrazide, hexamethylenediamine, polyvinylalcohol, bisphenol A diglycidyl ether, 1,4-butanediol diglycidyl ether, blocked polyisocyanates (e.g. Desmodur® BL 3175 SN from Covestro), pentaerythritol tris(3-(1-aziridinyl)propionate), polycarbodiimide crosslinker (e.g. CARBODILITE™ M V-02, CARBODILITE™ M V-02-L2, CARBODILITE™ SV-02, CARBODILITE™ M V-10, CARBODILITE™ M SW-12G, CARBODILITE™ M E-02, CARBODILITE™ M E-03A, CARBODILITE™ E-05, CARBODILITE™ M E-07s from Nisshinbo), and combinations thereof.

According to another embodiment, preferred crosslinkers c) may be selected from at least one of γ-glycidoxypropyltrimethoxysilane, 3-glycidoxypropylmethyldiethoxysilane, adipic acid dihydrazide, hexamethylenediamine, polyvinylalcohol, bisphenol A diglycidyl ether, 1,4-butanediol diglycidyl ether, blocked polyisocyanates (e.g. Desmodur® BL 3175 SN from Covestro), pentaerythritol tris(3-(1-aziridinyl)propionate), polycarbodiimide crosslinker (e.g. CARBODILITE™ M V-02, CARBODILITE™ M V-02-L2, CARBODILITE™ SV-02, CARBODILITE™ M V-10, CARBODILITE™ SW-12G, CARBODILITE™ M E-02, CARBODILITE™ M E-03A, CARBODILITE™ M E-05, CARBODILITE™ E-07s from Nisshinbo), and combinations thereof.

According to another embodiment, more preferred crosslinkers c) are γ-glycidoxypropyltrimethoxysilane, 3-glycidoxypropylmethyldiethoxysilane, adipic acid dihydrazide, hexamethylenediamine, polyvinylalcohol, polycarbodiimide crosslinker (e g. CARBODILITE™ M V-02, CARBODILITE™ M V-02-L2, CARBODILITE™ SV-02, CARBODILITE™ M V-10, CARBODILITE™ M SW-12G, CARBODILITE™ E-02, CARBODILITE™ M E-03A, CARBODILITE™ M E-05, CARBODILITE™ M E-07s from Nisshinbo), and combinations thereof.

The weight percentage of the crosslinking agent c) relative to the polymeric binder b) included in the composition for use as an electrode on a current collector within an electrical energy storage device containing a non-aqueous electrolyte is preferably within the range of 0-40 wt % by weight, and more preferably within the range of 0.01-20 wt % by weight, and even more preferably within 0.05-10 wt % by weight of the polymeric binder b).

### Optional Components/Additives:

The composition may also include the following optional components:
d) from 0-10% by weight of the polymeric binder of one or more wetting agents,
e) from 0-10% by weight of the polymeric binder of one or more dispersing agents,
f) from 0-10% by weight of the polymeric binder of one or more volatile organic compounds (VOC), and/or adhesion promoters, and/or coalescent agents,
g) from 0-200% by weight of the polymeric binder of one or more rheology modifier additives,
h) from 0-10% by weight of the polymeric binder of one or more additives comprising, consisting of or consisting essentially of anti-setting agents, surfactants, and mixtures thereof.

Surfactants and/or anti-settling agents may be added to the binder slurry composition at 0 to 10 parts, preferably from 0.1 to 10 parts, and more preferably 0.5 to 5 parts per 100 parts of water. These anti-settling agents or surfactants are added to the binder dispersion post-polymerization, generally to improve the shelf stability, and provide additional stabilization during slurry preparation. Some surfactant/anti-settling agent is also present in the composition remaining from the polymerization process. Useful anti-settling agents include, but are not limited to, ionic surfactants such as salts of alkyl sulfates, sulfonates, phosphates, phophonates (such as sodium lauryl sulfate and ammonium lauryl sulfate) and salts of partially fluorinated alkyl sulfates, carboxylates, phosphates, phosphonates (such as those sold under the CAPSTONE brandname by DuPont), and non-ionic surfactants such as the TRITON X series (from Dow) and PLURONIC series (from BASF). In one embodiment, only anionic surfactants are used. It is preferred that no fluorinated surfactants are present in the composition, either residual surfactant from the polymerization process, or added post-polymerization in forming or concentrating an aqueous dispersion.

Wetting agents may be incorporated into the composition at from 0 to 5 parts, and preferably from 0 to 3 parts per 100 parts of water. Surfactants can serve as wetting agents, but wetting agents may also include non-surfactants. In some embodiments, the wetting agent can be an organic solvent. The presence of optional wetting agents permits uniform dispersion of powdery inorganic material(s) into aqueous dispersion of vinylidene fluoride polymer. Useful wetting agents include, but are not limited to, ionic and non-ionic surfactants such as the TRITON series (from Dow) and the PLURONIC series (from BASF), and organic liquids that are compatible with the aqueous dispersion, including but not limited to NMP, DMSO, and acetone.

Thickeners and rheology modifiers may be present in the fluoropolymer separator composition at from 0 to 10 parts, preferably from 0 to 5 parts per 100 parts of water. The addition of water-soluble thickener or rheology modifier to the above dispersion prevents or slows down the settling of inorganic powdery materials while providing appropriate slurry viscosity for a coating process. Useful thickeners include, but are not limited to the ACRYSOL series (from Dow Chemical); Rheotech series (from Coatex), Viscoatex series (from Coatex) partially neutralized poly (acrylic acid) or poly (methacrylic acid) such as CARBOPOL from Lubrizol or Viscodis 100N from Coatex; and carboxylated alkyl cellulose, such as carboxylated methyl cellulose (CMC). Adjustment of the formulation pH can improve the effectiveness of some of the thickeners. In addition to organic rheology modifiers, inorganic rheology modifiers can also be used alone or in combination. Useful inorganic rheology modifiers include, but are not limited to, inorganic rheology modifiers including but not limited to natural clays such as montmorillonite and bentonite, manmade clays such as laponite, and others such as silica, and talc.

An optional fugitive adhesion promoter helps to produce the interconnectivity needed in coatings formed from the composition of the invention. By “fugitive adhesion promoter” as used herein is meant an agent that increases the interconnectivity of the composition after coating. The fugitive adhesion promoter is then capable of being removed from the formed substrate generally by evaporation (for a chemical) or by dissipation (for added energy).

The fugitive adhesion promoter can be a chemical material, an energy source combined with pressure, or a combination, used at an effective amount to cause interconnectivity of the components of the aqueous composition during formation of the electrode. For chemical fugitive adhesion promoters, the composition contains 0 to 150 parts, preferably 0 to 100 parts, and more preferably from 0 to 30 parts, of one or more fugitive adhesion promoters per 100 parts of water. Preferably this is an organic liquid, that is soluble or miscible in water. This organic liquid acts as a plasticizer or coalescent agent acrylic particles, making them tacky and capable of acting as discrete adhesion points during the drying step. The binder particles are able to soften, flow and adhere to powdery materials during drying stage, resulting in electrodes with high connectivity that are non-reversible. In one embodiment a useful organic solvent or coalescent agents include, but are not limited to those in the table below.

| Coalescent | Company | VOC |
|---|---|---|
| Texano ™ | Eastman | VOC |
| Optifilm ™ 400 | Eastman | Zero |
| Velate ™ 368 | Eastman | Low |
| Butyl Carbitol ™ | Dow | VOC |
| Dowanol ™ DPM | Dow | VOC |
| Citroflex ® 4 | Vertellus Specialties | Zero |
| Benzoflex ™ 50 | Eastman | Zero |
| Loxanol ® CA5310 | BASF | Zero |

In the case of energy as the fugitive adhesion promoter, useful energy sources include, but are not limited to, heat, IR radiation, and radio frequency (RF). For heat alone, the temperature during the processing of the electrode should be about 20 to 50° C. above the glass transition point of the acrylic binder. When energy alone is used as the fugitive adhesion promoter, it is preferred that the heat is combined with pressure—such as a calendering step, for good interconnectivity and high adhesion to current collector and high cohesion within electrode.

### Applications:

The inventive composition for an electrode is suitable for use on a current collector within an electrical energy storage device containing a non-aqueous electrolyte, such as a secondary battery device. Such devices include an anode, a cathode, a separator between the anode and the cathode, and electrolyte.

An electrode, such as an anode including the composition, in dried form, for use as an electrode on a substrate (i.e., current collector) within an electrical energy storage device disclosed herein is provided. Such an electrode is preferably used as anode and therefore most preferably the composition disclosed for use as an electrode disclosed herein is applied to an electroconductive substrate current collector made from copper.

Also provided is an electrical energy storage device selected from a non-aqueous-type battery, a capacitor, and a membrane electrode assembly that incorporates electrode comprising an electroconductive substrate coated on at least one surface with the composition for use as an electrode as disclosed herein, in dried form.

### Kits

The composition for use as an electrode on a current collector within an electrical energy storage device containing a non-aqueous electrolyte may be provided in the form of a kit. Thus, the at least one crosslinking agent c) may be combined with the polymeric binder b) to form a first component of the kit; and the at least one particulate electrode-forming material a) may be a second component of the kit.

Another embodiment of a kit is also provided. In this embodiment, the at least one particulate electrode-forming material a) may be the a first component of the kit; the polymeric binder b) may be a second component of the kit; and the at least one crosslinking agent c) may be a third component of the kit.

### EXAMPLES

Electrodes were calendared at very high pressure at room temperature to arrive at desired porosity. Porosity of the electrodes were back calculated from its expected (weight contribution of each component) and apparent densities where the apparent densities was obtained by measuring weight and volume of the electrode using micrometer and 5 decimal point balance.

Volume average particle size was measured by dynamic light scattering using a Nanotrac UPA150 from Microtrac.

### Example 1: Production of Binder

Into a 1 gallon reactor was introduced an initial charge composed of 226.94 g of deionized water and 1.12 g of Rhodacal® A-246 MBA. 329.70 g of 2-ethylhexyl acrylate, 293.17 g of styrene, 28.91 g of methyl methacrylate, 74.40 g of sodium 4-vinylbenzenesulfonate were weighed out in a first glass beaker and mixed with 17.20 g of Rhodacal® A-246 MBA and 492.00 g of deionized water to prepare monomer pre-emulsion. 1.76 g of ammonium persulfate was weighed in a second glass beaker, dissolved in 12.00 g of deionized water to prepare initial initiator. 0.80 g of ammonium persulfate was dissolved in 25.60 g water in a third beaker to prepare delayed initiator. The contents of the reactor were heated to a temperature of 83±2° C. 61.77 g of the monomer pre-emulsion and the initial initiator were first introduced into the reactor. After the peak of the reaction exotherm, the remaining of the monomer pre-emulsion and the delayed initiator were feed into the reactor while keeping the reactor temperature 90±2° C. The delayed initiator solution was feed into the reactor over 260 mins. The monomer pre-emulsion was feed into the reactor over 4 stages. 293.4 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 2.60 g of 70% t-butyl hydroperoxide and 18.64 g of deionized water was prepared in a glass beaker. A post reducer solution containing 1.80 g of Bruggolite® FF6M and 36.00 g of deionized water was also prepared in a glass beaker. The post oxidizer and post reducer solution were then feed into the reactor over 75 mins after the 30 mins cook. The medium was allowed to cool, and filtered.

### Example 2: Production of Binder

The binder was produced in a similar manner as in Example 1 except that monomers selection and ratio were different. The weight percentage of each monomer used is listed in Table 1.

### Example 3: Production of Binder

The binder was produced in a similar manner as Example 1 except that monomers selection and ratio were different. The weight percentage of each monomer used is listed in Table 1.

### Example 4: Production of Binder

The binder was produced in a similar manner as compared to Example 1 except that monomers selection and ratio were different. The weight percentage of each monomer used is listed in Table 1.

### Example 5: Production of Binder

The binder was produced in a similar manner as Example 1 except that monomers selection and ratio were different. The weight percentage of each monomer used is listed in Table 1.

### Example 6: Production of Binder

Into a 1 gallon reactor was introduced an initial charge composed of 435.00 g of deionized water and 3.26 g of REASOAP SR-1025. 351.28 g of 2-ethylhexyl acrylate, 268.31 g of styrene, 31.43 g of methyl methacrylate, 4.9 g divinylbenzene, 25.22 g Sipomer® PAM600, 39.62 g methacrylic acid, 87.16 g of sodium 4-vinylbenzenesulfonate were weighed out in a first glass beaker and mixed with 31.38 g of REASOAP SR-1025 and 480.00 g of deionized water to prepare monomer pre-emulsion. 1.91 g of ammonium persulfate was weighed in a second glass beaker, dissolved in 20.00 g of deionized water to prepare initial initiator. 0.87 g of ammonium persulfate was dissolved in 25.60 g water in a third beaker to prepare delayed initiator. The contents of the reactor were heated to a temperature of 83±2° C. 65.96 g of the monomer pre-emulsion and the initial initiator were first introduced into the reactor. After the peak of the reaction exotherm, the remaining of the monomer pre-emulsion and the delayed initiator were feed into the reactor while keeping the reactor temperature 90±2° C. The delayed initiator solution was feed into the reactor over 260 mins. The monomer pre-emulsion was feed into the reactor over 4 stages. 313.34 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 2.83 g of 70% t-butyl hydroperoxide and 18.64 g of deionized water was prepared in a glass beaker. A post reducer solution containing 1.96 g of Bruggolite® FF6M and 36.00 g of deionized water was also prepared in a glass beaker. The post oxidizer and post reducer solution were then feed into the reactor over 75 mins after the 30 mins cook. The medium was allowed to cool, and filtered.

### Example 7: Production of Binder

Into a 1 gallon reactor was introduced an initial charge composed of 533.67 g of deionized water and 1.40 g of Rhodacal® A-246 MBA. 412.12 g of 2-ethylhexyl acrylate, 411.71 g of styrene, 36.14 g of methyl methacrylate, 15.22 g acrylic acid, 15.07 g methacrylic acid, 15.53 g of sodium 4-vinylbenzenesulfonate were weighed out in a first glass beaker and mixed with 21.50 g of Rhodacal® A-246 MBA and 365.00 g of deionized water to prepare monomer pre-emulsion. 2.20 g of ammonium persulfate was weighed in a second glass beaker, dissolved in 15.00 g of deionized water to prepare initial initiator. 1 g of ammonium persulfate was dissolved in 32.00 g water in a third beaker to prepare delayed initiator. The contents of the reactor were heated to a temperature of 83±2° C. 64.61 g of the monomer pre-emulsion and the initial initiator were first introduced into the reactor. After the peak of the reaction exotherm, the remaining of the monomer pre-emulsion and the delayed initiator were feed into the reactor while keeping the reactor temperature 90±2° C. The delayed initiator solution was feed into the reactor over 260 mins. The monomer pre-emulsion was feed into the reactor over 4 stages. 306.90 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 3.25 g of 70% t-butyl hydroperoxide and 23.30 g of deionized water was prepared in a glass beaker. A post reducer solution containing 2.25 g of Bruggolite® FF6M and 45.00 g of deionized water was also prepared in a glass beaker. The post oxidizer and post reducer solution were then feed into the reactor over 75 mins after the 30 mins cook. The medium was allowed to cool, and filtered.

### Example 8: Production of Binder

The binder was produced in a similar manner as Example 7 except that monomers selection and ratio were different. The weight percentage of each monomer used is listed in Table 1.

### Example 9: Production of Binder

Into a 1 gallon reactor was introduced an initial charge composed of 533.67 g of deionized water and 0.90 g of Rhodacal® A-246 MBA. 367.74 g of 2-ethylhexyl acrylate, 434.33 g of styrene, 36.14 g of methyl methacrylate, 16.24 g Sipomer® PAM4000, 32.48 g hydroxyethyl acrylate, 18.04 g of sodium 4-vinylbenzenesulfonate, 2.26 g of divinylbenzene were weighed out in a first glass beaker and mixed with 21.50 g of Rhodacal® A-246 MBA and 365.00 g of deionized water to prepare monomer pre-emulsion. 2.20 g of ammonium persulfate was weighed in a second glass beaker, dissolved in 15.00 g of deionized water to prepare initial initiator. 1.00 g of ammonium persulfate was dissolved in 32.00 g water in a third beaker to prepare delayed initiator. The contents of the reactor were heated to a temperature of 83±2° C. 63.91 g of the monomer pre-emulsion and the initial initiator were first introduced into the reactor. After the peak of the reaction exotherm, the remaining of the monomer pre-emulsion and the delayed initiator were feed into the reactor while keeping the reactor temperature 90±2° C. The delayed initiator solution was feed into the reactor over 260 mins. The monomer pre-emulsion was feed into the reactor over 4 stages. 303.57 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 3.90 g of 70% t-butyl hydroperoxide and 23.30 g of deionized water was prepared in a glass beaker. A post reducer solution containing 2.70 g of Bruggolite® FF6M and 45.00 g of deionized water was also prepared in a glass beaker. The post oxidizer and post reducer solution were then feed into the reactor over 75 mins after the 30 mins cook. The medium was allowed to cool, and filtered.

### Example 10: Production of Binder

Into a 1 gallon reactor was introduced an initial charge composed of 600.00 g of deionized water, 0.40 g of ammonium hydroxide and 1.26 g of Rhodacal® A-246 MBA. 320.00 g of 2-ethylhexyl acrylate, 197.26 g of styrene, 24.37 g of methyl methacrylate, 19.55 g Sipomer® PAM600, 10.95 g of diacetone acrylamide, 40.75 g of acrylonitrile, 12.17 g of AMPS® 2405 were weighed out in a first glass beaker and mixed with 3.65 of Rhodacal® A-246 MBA and 273.75 g of deionized water to prepare monomer pre-emulsion 1. 106.67 g of 2-ethylhexyl acrylate, 79.31 g of styrene, 8.12 g of methyl methacrylate, 6.52 g Sipomer® PAM600, 3.65 g of diacetone acrylamide, 4.06 g of AMPS® 2405 were weighed out in a second glass beaker and mixed with 1.22 of Rhodacal® A-246 MBA and 91.25 g of deionized water to prepare monomer pre-emulsion 2. 1.98 g of ammonium persulfate was weighed in a third glass beaker, dissolved in 15.00 g of deionized water to prepare initial initiator. 0.90 g of ammonium persulfate was dissolved in 40.00 g water in a fourth beaker to prepare delayed initiator. 3.60 ammonium hydroxide dissolved in 29.00 g of deionized water in a fifth beaker to prepare third stream base feed. The contents of the reactor were heated to a temperature of 83±2° C. 60.46 g of the monomer pre-emulsion 1 and the initial initiator were first introduced into the reactor. After the peak of the reaction exotherm, the remaining of the monomer pre-emulsion 1, the third stream base feed and the delayed initiator were feed into the reactor while keeping the reactor temperature 90±2° C. The third stream based feed and the delayed initiator solution were feed into the reactor over 260 mins. The monomer pre-emulsion 1 was feed into the reactor over 3 stages. 280.80 g of the monomer pre-emulsion 1 was feed into the reactor over 45 mins, followed by a 15 mins feed pause. Then the rest of the monomer pre-emulsion 1 was feed into the reactor following the same feeding profile over two stages. After the completion of monomer pre-emulsion 1 feed and 15 mins hold. The monomer pre-emulsion 2 was feed into the reactor over 45 mins. After the completion of the delayed initiator feed and the third stream base feed over 260 mins, the contents in reactor was cooked for 30 mins before allowing the medium to cool to 70° C. During the 30 mins cook, a post oxidizer solution containing 4.60 g of 70% t-butyl hydroperoxide and 25 g of deionized water was prepared in a glass beaker. A post reducer solution containing 3.20 g of Bruggolite® FF6M and 40.00 g of deionized water was also prepared in a glass beaker. The post oxidizer and post reducer solution were then feed into the reactor over 75 mins after the 30 mins cook. The medium was allowed to cool to room temperature. Then mixture of 4.00 g of ammonium hydroxide and 4.00 g of deionized water was added to the medium. The latex was then filtered.

### Example 11: Production of Binder

Into a 1 gallon reactor was introduced an initial charge composed of 365.00 g of deionized water, 0.40 g of ammonium hydroxide and 1.40 g of Rhodacal® A-246 MBA. 470.09 g of 2-ethylhexyl acrylate, 346.56 g of styrene, 36.14 g of methyl methacrylate, 29.00 g Sipomer® PAM600, 31.57 g of AAEM, 4.51 g of Silane A174 were weighed out in a first glass beaker and mixed with 5.40 g of Rhodacal® A-246 MBA and 365.00 g of deionized water to prepare monomer pre-emulsion. 2.20 g of ammonium persulfate was weighed in a second glass beaker, dissolved in 15.00 g of deionized water to prepare initial initiator. 1.00 g of ammonium persulfate was dissolved in 32.00 g water in a third beaker to prepare delayed initiator. 4.00 ammonium hydroxide dissolved in 29.00 g of deionized water in a fourth beaker to prepare third stream base feed. The contents of the reactor were heated to a temperature of 83±2° C. 60.46 g of the monomer pre-emulsion and the initial initiator were first introduced into the reactor. After the peak of the reaction exotherm, the remaining of the monomer pre-emulsion, the third stream base feed and the delayed initiator were feed into the reactor while keeping the reactor temperature 90±2° C. The delayed initiator solution and the third stream base solution were feed into the reactor over 260 mins. The monomer pre-emulsion was feed into the reactor over 4 stages. 280.8 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator and third stream base feeds over 260 mins, the contents in reactor was cooked for 30 mins before allowing the medium to cool to 70° C. During the 30 mins cook, a post oxidizer solution containing 4.60 g of 70% t-butyl hydroperoxide and 25.00 g of deionized water was prepared in a glass beaker. A post reducer solution containing 3.20 g of Bruggolite® FF6M and 40.00 g of deionized water was also prepared in a glass beaker. The post oxidizer and post reducer solution were then feed into the reactor over 75 mins after the 30 mins cook. The medium was allowed to cool, and filtered.

### Comparative Example 1: Production of Binder

Into a 1 gallon reactor was introduced an initial charge composed of 533.67 g of deionized water and 1.40 g of Rhodacal® A-246 MBA. 434.77 g of 2-ethylhexyl acrylate, 434.33 g of styrene, 36.14 g of methyl methacrylate were weighed out in a first glass beaker and mixed with 21.50 g of Rhodacal® A-246 MBA and 410.00 g of deionized water to prepare monomer pre-emulsion. 2.20 g of ammonium persulfate was weighed in a second glass beaker, dissolved in 15.00 g of deionized water to prepare initial initiator. 1.00 g of ammonium persulfate was dissolved in 32.00 g water in a third beaker to prepare delayed initiator. The contents of the reactor were heated to a temperature of 83±2° C. 66.84 g of the monomer pre-emulsion and the initial initiator were first introduced into the reactor. After the peak of the reaction exotherm, the remaining of the monomer pre-emulsion, the third stream base feed and the delayed initiator were feed into the reactor while keeping the reactor temperature 90±2° C. The delayed initiator solution and the third stream base were feed into the reactor over 260 mins. The monomer pre-emulsion was feed into the reactor over 4 stages. 317.48 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 2.60 g of 70% t-butyl hydroperoxide and 23.30 g of deionized water was prepared in a glass beaker. A post reducer solution containing 1.80 g of Bruggolite® FF6M and 45.00 g of deionized water was also prepared in a glass beaker. The post oxidizer and post reducer solution were then feed into the reactor over 75 mins after the 30 mins cook. The medium was allowed to cool, and filtered.

### Production of Negative Electrode Slurry

In a 125 mL polyethylene container of Thinky ARE-310, was placed seven 6.5 mm zirconia balls. 0.25 g of carbon black (Super P-Li from Timcal) plus 4.5 g of carboxymethyl cellulose (CMC) solution (BVH9 from Ashland Chemicals) at 1.5% solids in water and 9.1 g of graphite (GHDR 15-4 from Imerys) plus 2.5 gr of silicon (amorphous silicon from NanoAmor) were added and mixed at 2000 rpm for 2 minutes. Then, 1.0 g of CMC solution was successively added and mix at 2000 rpm for 2 minutes, followed by another CMC solution addition and mixing to reach 10.0 g total CMC solution addition. Then 2.5 g of Examples above at 20% solids by weight was added and mixed for 2 minutes at 2000 rpm for two times.

### Electrodes Fabrication & Testing:

The slurries prepared above were cast on to copper foil with a wet thickness of about 110 μm and placed in to a convection oven for 30 min at 120° C. Then, the electrode was calendared to reach porosity of about 30% by volume. Adhesion measurements were performed with an Instron using 180 degree peel at 50 mm/min crosshead speed using 1 inch wide electrode specimens according to ASTM-D903 (2017).

TABLE 1
Polymer binder compositions by monomer weight percentage, latex
particle size and the corresponding electrodes peel adhesion.

| | Exp. 1 | Exp. 2 | Exp. 3 | Exp. 4 | Exp. 5 | Exp. 6 |
|---|---|---|---|---|---|---|
| Sty ii) | 40.5 | 40.5 | 40.5 | 40.5 | 40.5 | 34.1 |
| 2EHA ii) | 45.5 | 45.5 | 45.5 | 45.5 | 45.5 | 44.6 |
| MMA ii) | 4 | 4 | 4 | 4 | 4 | 4 |
| SSS i) | 10 | | | | | 10 |
| MAA i) | | 10 | | | | 5 |
| PAM600 i) | | | 10 | | | 1.8 |
| PAM4000 i) | | | | | | |
| AA i) | | | | 10 | | |
| AMPS i) | | | | | 10 | |
| DAAM iii) | | | | | | |
| HEA iii) | | | | | | |
| ACN ii) | | | | | | |
| AAEM iii) | | | | | | |
| A174 iii)/vi) | | | | | | |
| DVB iv) | | | | | | 0.5 |
| DAP iv) | | | | | | |
| Particle size | 128 | 111 | 110 | 147 | 176 | 187 |
| (nm) | | | | | | |
| Electrode | 57 | 38 | 37 | 41 | 36 | 32 |
| peel adhesion | | | | | | |
| (N/m) | | | | | | |
| | | | | | | Com. |
| | Exp. 7 | Exp. 8 | Exp. 9 | Exp. 10 | Exp. 11 | Exp. 1 |
| Sty ii) | 45.5 | 45.3 | 48 | 34 | 38.3 | 48 |
| 2EHA ii) | 45.5 | 45.3 | 40.6 | 52.4 | 51.9 | 48 |
| MMA ii) | 4 | 4 | 4 | 4 | 4 | 4 |
| SSS i) | 1.7 | 1.7 | 1.8 | | | |
| MAA i) | 1.7 | 1.7 | | | | |
| PAM600 i) | | | | 1.8 | 1.8 | |
| PAM4000 i) | 1.7 | | 1.8 | | | |
| AA i) | | 1.7 | | | | |
| AMPS i) | | | | 1 | | |
| DAAM iii) | | | | 1.8 | | |
| HEA iii) | | | 3.6 | | | |
| ACN ii) | | | | 5 | | |
| AAEM iii) | | | | | 3.5 | |
| A174 iii)/vi) | | | | | 0.5 | |
| DVB iv) | | | 0.2 | | | |
| DAP iv) | | 0.5 | | | | |
| Particle size | 122 | 127 | 152 | 120 | 134 | 126 |
| (nm) | | | | | | |
| Electrode | 51 | 55 | 42 | 45 | 26 | NA |
| peel adhesion | | | | | | |
| (N/m) | | | | | | |

Abbreviations:
2EHA = 2-ethylhexyl acrylate ii)
A174 = 3-(triethoxysilyl)propyl methacrylate iii)/vi)
AA = acrylic acid i)
AAEM = acetoacetoxyethyl methacrylate iii)
ACN = acrylonitrile ii)
AMPS = 2-acrylamido-2-methylpropane sulfonic acid i)
CMC = carboxymethylcellulose
DAAM = diacetone acrylamide iii)
DAP = diallyl phthalate iv)
DVB = divinylbenzene iv)
HEA = 2-hydroxyethyl acrylate iii)
MMA = methyl methacrylate ii)
MAA = methacrylic acid i)
PAA = polyacrylic acid
PAM 4000 = Sipomer ® PAM 4000 (phosphate ester of ethyl methacrylate) i)
PAM 600 = Sipomer ® PAM 600 (phosphate ester of polypropylene glycol monomethacrylate) i)
SBR = styrene butadiene rubber
SSS = sodium 4-vinylbenzenesulfonate i)
Sty = styrene ii)

All the latex examples in Table 1 were evaluated in a negative electrode formulation to compare their performance in slurry preparation and electrode adhesion. In the slurry preparation step, stable slurries were prepared with all the inventive Examples 1-11. However, slurry preparation with the Comparative Example 1 was unsuccessful. Coagulated solid was observed when preparing slurry with Comparative Example 1. A direct comparison between the inventive Examples 1-5 and the Comparative Example in the slurry preparation demonstrates improvement provided by the ionic monomers (monomer i).

Table 1 lists peel adhesion of electrode prepared with inventive Examples 1-11. Peel adhesion is a measure of binder's binding ability in electrode. High peel adhesion is preferred for electrode processing and battery cycling. 10 N/m or larger is generally preferred for electrode processing. It can be seen that peel adhesion of all inventive Examples are larger than 10 N/m. Peel adhesion for Comparative Example 1 is not available due to unstable slurry.

Although the invention is illustrated and described herein with reference to specific embodiments, the invention is not intended to be limited to the details shown. Rather, various modifications may be made in the details within the scope and range of equivalents of the claims and without departing from the invention.

1. A composition for use as an electrode on a current collector within an energy storage device containing a non-aqueous electrolyte, the composition comprising:
a) at least one particulate electrode-forming material; and
b) a polymeric binder, comprising, as polymerized monomers:
i) 0.1-50% by weight of the polymeric binder of at least one ethylenically unsaturated ionic monomer comprising at least one functional group selected from carboxylate, sulfonate, sulfate, phosphate, phosphonate, and/or acids, and/or salts, and/or anhydrides thereof;
ii) 10-99% by weight of the polymeric binder of at least one non-ionic monoethylenically unsaturated monomer;
iii) 0-5% by weight of the polymeric binder of at least one ethylenically unsaturated monomer comprising at least one functional group selected from N-methylol amide, N-alkylol amide, hydroxyl group, epoxy, silane, keto, or combinations thereof;
iv) 0-5% by weight of the polymeric binder of at least one monomer comprising at least two ethylenic unsaturations;
v) 0-30% by weight of the total polymeric binder of at least one ethylenically unsaturated monomer comprising at least one functional group selected from silane, ureido, amine, hydroxyl group, and combinations thereof; and
vi) 0-30% by weight of the total polymeric binder of at least one oxyalkylated monomer with ethylenic unsaturation and terminated by a hydrogen or aryl or alkyl chain, having the following formula: 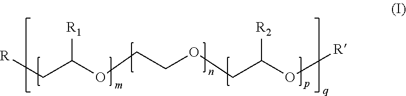
wherein:
m and p represent a number of alkylene oxide units of from 0 and 150,
n represents a number of ethylene oxide units of from 5 and 150,
q represents a whole number at least equal to 1 and such that 5≤(m+n+p)q≤150,
R₁ and R₂ represent methyl or ethyl,
R represents a group comprising at least one polymerizable olefinic unsaturation, and mixtures thereof, and
R′ represents a hydrogen or aryl chain with 5 to 60 carbon atoms or an alkyl chain end with 1 to 60 carbon atoms;
wherein the total of components b) i) through b) vi) add up to 100% by weight of polymeric binder b),
and
wherein the polymeric binder b) has a Tg of 55° C. or less and/or a minimum film forming temperature of 25° C. or less;
c) from 0-40% by weight of the polymeric binder of at least one crosslinking agent capable of reacting with the polymeric binder b);
d) from 0-10% by weight of the polymeric binder of one or more wetting agents;
e) from 0-10% by weight of the polymeric binder of one or more dispersing agents;
f) from 0-10% by weight of the polymeric binder of one or more volatile organic compounds (VOC), and/or adhesion promoters, and/or coalescent agents;
g) from 0-200% by weight of the polymeric binder of one or more rheology modifier additives; and
h) from 0-10% by weight of the polymeric binder of one or more additives comprising at least one of anti-setting agents, surfactants, and mixtures thereof.

2. The composition of claim 1, wherein the monomer iii) comprises at least one of N-alkylol(meth)acrylamide, vinyl glycidyl ether, allyl glycidyl ether, glycidyl (meth)acrylate, diacetone acrylamide, acetoacetoxyethyl methacrylate, (meth)acryloxyalkyltrialkoxysilanes, vinyltrialkoxysilanes, and mixtures thereof.

3. The composition of claim 1, wherein the at least one crosslinking agent c) comprises at least one of epoxy, amine, alcohol, blocked isocyanate, carbodiimide, polyfunctional aziridine, silane, and mixtures thereof.

4. The composition of claim 1, wherein the polymeric binder b) has a volume average particle size of from 30-500 nm, or is a mixture of various particle sizes from 30 to 500 nm.

5. The composition of claim 1, wherein the i) at least one ethylenically unsaturated ionic monomer comprising at least one functional group comprises at least one of (meth) acrylic acid, 2-carboxyethyl acrylate, 2-polycarboxy ethyl acrylate, mono-ester of itaconic acid, maleic acid, fumaric acid, crotonic acid, itaconic acid, 2-acrylamide-2-methylpropane sulfonic acid, 4-styrenesulfonic acid, vinylsulfonic acid, 2-sulfoethyl methacrylate, phosphate esters of polyalkylene glycol mono(meth)acrylate, polyalkylene glycol allyl ether phosphate, vinylphosphonic acid, 2-(methacryloyloxy)ethyl phosphonic acid; and/or acids, and/or salts, and/or anhydrides thereof; and mixtures thereof.

6. The composition of claim 1, wherein the ii) at least one non-ionic monoethylenically unsaturated monomer comprises at least one of C1 to C12 alkyl (meth)acrylates, styrene and derivatives thereof, vinyl acetate, vinyl versatate, (meth)acrylamide, (meth)acrylonitrile and derivatives thereof, diisobutylene, vinylpyrrolidone, vinylcaprolactam, or mixtures thereof.

7. The composition of claim 1, wherein the iv) at least one monomer comprising at least two ethylenic unsaturations comprises at least one of allylic ethers obtained from polyols; acrylic or methacrylic esters obtained from polyols; divinyl naphthalene; trivinylbenzene; 1,2,4-trivinylcyclohexane; triallyl pentaerythritol; diallyl pentaerythritol; diallyl sucrose; trimethylolpropane diallyl ether; 1,6-hexanediol di(meth)acrylate; allyl (meth)acrylate; diallyl itaconate; diallyl fumarate; diallyl maleate; butanediol dimethacrylate; ethylene di(meth)acrylate, poly(ethylene glycol) di(meth)acrylate; trimethylolpropane tri(meth)acrylate; methylenebis(meth)acrylamide; triallylcyanurates, diallyl phthalate; divinylbenzene or mixtures thereof.

8. The composition of claim 1, wherein the v) at least one ethylenically unsaturated monomer comprising at least one functional group comprising at least one of silane, ureido amine, hydroxyl group, or combinations thereof comprises at least one of (meth)acryloxyalkyltrialkoxysilanes, vinyltrialkoxysilanes, (meth)acrylate ester of substituted urea, (meth)acrylamide of substituted urea, allyl ether of substituted urea, aminoalkyl (meth)acrylate, hydroxyalkyl (meth)acrylate, and mixtures thereof.

9. The composition of claim 1, wherein the a) at least one particulate electrode-forming material comprises one or more materials selected from furnace black, acetylene black, Ketjen carbon black, carbon nanotubes (CNTs), synthetic graphite, natural graphite, hard carbon, activated soft carbon, carbon black, graphene, mesoporous carbon, amorphous silicon, semi-crystalline silicon, silicon oxides, silicon nanowires, tin, tin oxides, germanium, lithium titanate, and mixtures or composites thereof.

10. An electrode comprising an electroconductive substrate coated on at least one surface with the composition of claim 1 in dried form.

11. A device comprising the electrode of claim 10, selected from the group consisting of a non-aqueous-type battery, a capacitor, and a membrane electrode assembly.

12. A kit comprising the composition of claim 1 wherein:
the at least one crosslinking agent c) is combined with the polymeric binder b) to form a first component of the kit; and
wherein the a) at least one particulate electrode-forming material comprises a second component of the kit.

13. A kit comprising the composition of claim 1 wherein:
the a) at least one particulate electrode-forming material comprises a first component of the kit; the polymeric binder b) comprises a second component of the kit; and the at least one crosslinking agent c) comprises a third component of the kit.
